(19) United States
(12) Patent Application Publication
(10) Pub. No.: US 2009/0125378 A1
(43) Pub. Date: May 14, 2009

(54) System and Method For Eliciting Subjective Probabilities

(76) Inventors: Jason Trahan, Kalamazoo, MI (US); Paul Engelmann, Plainwell, MI (US)

Correspondence Address: FLYNN THIEL BOUTELL & TANIS, P.C., 2026 RAMBLING ROAD, KALAMAZOO, MI, 49008-1631, US

(21) Appl. No.: 12/087,977

(22) PCT Filed: Jan. 17, 2007
(86) PCT No.: PCT/US2007/001444

§ 371 Date: Jul. 17, 2008

Related U.S. Application Data
(60) Provisional application No. 60/759,329, filed on Jan. 17, 2006.

(51) Int. Cl. G06Q 10/00; G06F 17/00; G06F 3/048; G06F 15/18

(52) U.S. Cl. 705/10; 706/11; 706/12; 715/833

(57) ABSTRACT

A system and method for dynamically interacting with a human expert by means of a graphical user interface to elicit subjective probabilities that can subsequently be utilized in a probabilistic network. After the qualifications of an expert are obtained, the graphical user interface presents the expert with a series of questions. To assure that relatively accurate and consistent probabilities are subsequently provided by the expert, the graphical user interface incorporates numerous novel features that are designed to mitigate the effects of various biases that otherwise tend to skew the results acquired in traditional probability elicitation processes.

### CROSS-REFERENCE TO RELATED APPLICATION

This application claims the benefit of U.S. Provisional Application No. 60/759,329, filed Jan. 17, 2006.

### FIELD OF THE INVENTION

The present invention relates to a system and method for eliciting subjective probabilities and, more specifically, to a system and method for generating a graphical user interface that promotes the acquisition of subjective probabilities that aid in the modeling and problem solving capabilities of probabilistic networks.

### BACKGROUND OF THE INVENTION

Probabilistic networks can be extremely useful tools that aid in the modeling and solving of problems that arise in numerous settings. A probabilistic network is comprised of three components, including: 1) a set of nodes representing (random) variables or uncertain quantities, each with a finite set of mutually exclusive and exhaustive values that represent possible states, 2) a set of arcs signifying a direct causal relationship between the linked nodes and 3) a probability table at each node, specifying the likelihood that a node will be in a particular state. In cases where people are used, these prior probabilities reflect the subject of confidence and certainty an expert believes about an uncertain event.

These networks are referred to as Bayesian belief networks. Other types of probabilistic networks are possible, and may be utilized depending on the field of study and the problem being addressed.

To illustrate the problem solving potential of a Bayesian network, consider the following example with reference to FIG. 1, which depicts a simple Bayesian network configured to address a potential problem concerning the development of a new product in a manufacturing setting.

Imagine the manager of a program is deciding how to handle a variety of newly awarded work, so that the deadline is met. As depicted in the Bayesian network of FIG. 1, wherein the arrows represent causal relationships, two causes that influence the ability to meet the deadline are the number of engineering changes (ECs) and the level of experience of the designer. Generally, as the number of engineering changes increases and the experience of a designer decreases, the probability of meeting a deadline diminishes. In turn, one measure the manager uses as an indicator for the expected number of engineering changes is the familiarity of the product. Typically, unfamiliar designs (and materials) mean more engineering changes. Product familiarity also influences the manager's assignment of certain products to certain designers. Experienced designers are usually best suited to handle those never-been-seen-before products.

In most cases, a good manager understands these relationships and handles the situation appropriately. But what if all experienced designers are already being utilized or are unavailable and several unfamiliar designs arrive that demand a very short launch (a not too unlikely scenario)? More importantly, the work is from a customer that the manufacturing company has wanted to establish a working relationship with for some time, and as such, realizes that the likelihood of being on-time is of utmost importance. A Bayesian network supports the decisions of the manager by providing quantitative knowledge in a series of what-if scenarios.

Consider the scenario of FIG. 2A as the normal operating conditions of a company. For example, 50% of the products handled by the company are familiar, while an average of almost 81% of the deadlines are on-time.

Consider the worst case scenario presented in FIG. 2B as the situation described earlier. An unfamiliar product in the hands of a novice designer increases the number of engineering changes and decreases by 13% the ability to meet the deadline, which is now at 68%.

However, if the manager can free up an experienced designer, the timing returns to near normal operating conditions as shown in the improved scenario depicted in FIG. 2C.

The best-case scenario, as shown in FIG. 2D, raises the likelihood of being on-time to 93%. Here, the Bayesian network relieves the manager's uncertainty by confirming his or her belief and supports his or her decision.

One may question where the probabilities in a Bayesian network are acquired or how they are calculated. Although the answer is simple, it is quite difficult to achieve. Data often come from two sources 1) literature, such as historical records, equations and guidelines and 2) experts (i.e. interviews, surveys, monitoring). The data are obtained according to tables that make up all combinations of every possible scenario. As shown in FIG. 3, the previous simple example of FIG. 2 require 24 probabilities. For example, the 0.85 probability within the table for number of ECs is an average response to the following question: “Given that the product is familiar, what is the likelihood that there are zero engineering changes?” (P(x) is the probability of being in state X).

It is easy to recognize that as the number of variables increases and/or the number of categories of a variable increases, the size of the probability table grows rapidly. In real-life applications of probabilistic or Bayesian networks, the number of probabilities that need to be gathered can frequently run in the hundreds and even thousands. Many of these probabilities have to be acquired from experts, while others can be collected through research utilizing various tools such as simulation software and interpolation.

The structured procedure designed to gather knowledge from human experts in a domain is known as expert judgment elicitation. Probability elicitation is a special case of expert elicitation that focuses on collecting subjective probabilities for uncertain events. In Bayesian analysis, these are interpreted as prior probabilities, which reflect the confidence or certainty an expert places on a particular hypothesis before considering new data. This differs from classical or frequentist probabilities in which the relative frequency of an event can be calculated and verified via statistical observation and experiment.

For most real-world problems, the probability elicitation process is laborious and time-consuming since experts must specify their belief for each and every condition in the model. Furthermore, the activity is prone to a variety of errors and biases. If not designed and conducted carefully, the probabilities may be poor estimates. Although decision theory has proposed several elicitation schemes to reduce these errors, they tend to be cumbersome and often infeasible for models that include more than a few variables.

Over the past decade, there has been a flurry of research in elicitation theory devoted to developing suitable elicitation methods. The focus has been on integrating efficiency with methods that protect subjective probabilities from common biases. Works in this field have addressed protocols for probability elicitation, graphical representations of probabilities, types of response scales, ways to phrase questions and conditions and tools to minimize bias, such as interactive software. Unfortunately, there has been little consensus in adopting a strategy that incorporates all facets of the elicitation process. One reason for this appears to stem from the nuances of individual domains. It may be difficult to achieve a “one size fits all” approach to every problem. Another reason may exist due to a lack of agreement between elicitation theorists.

Accordingly, what is needed is a method and corresponding system for eliciting subjective probabilities so as to aid the modeling and problem solving capabilities of a probabilistic network while minimizing errors that arise due to various common biases that skew the elicited probabilities.

### SUMMARY OF THE INVENTION

A system and method for dynamically interacting with a human expert by means of a graphical user interface to elicit subjective probabilities that can subsequently be utilized in a probabilistic network. After the qualifications of an expert are obtained, the graphical user interface presents the expert with a series of questions. To assure that relatively accurate and consistent probabilities are subsequently provided by the expert, the graphical user interface incorporates numerous novel features that are designed to mitigate the effects of various biases that otherwise tend to skew the results acquired in traditional probability elicitation processes.

### BRIEF DESCRIPTION OF THE DRAWINGS

One or more embodiments of the present invention are illustrated by way of example and should not be construed as being limited to the specific embodiments depicted in the accompanying drawings, in which like references indicate similar elements and in which:

FIG. 1 illustrates a simple Bayesian network.

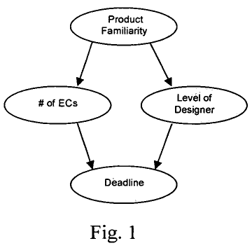

FIGS. 2A-2D illustrate various Bayesian network scenarios.

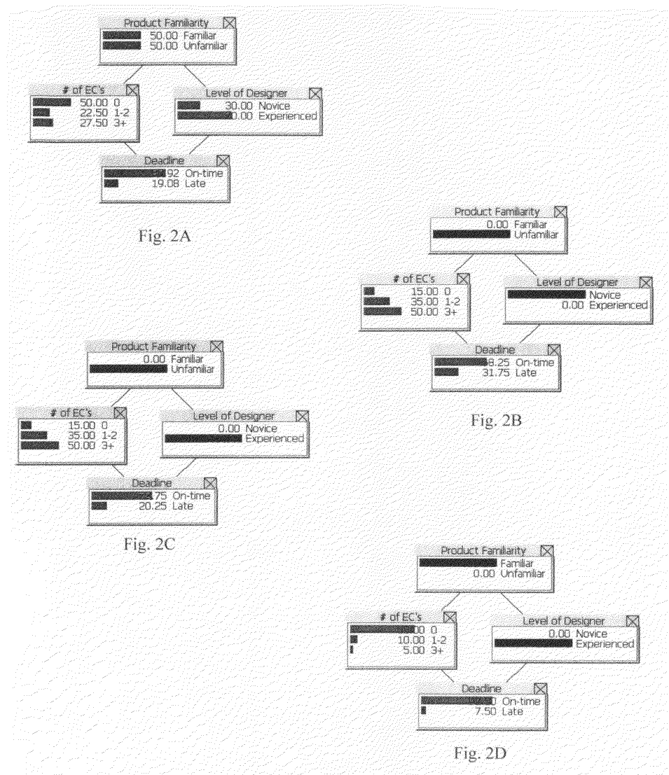

FIG. 3 illustrates a probability table associated with each variable of the Bayesian network of FIG. 1.

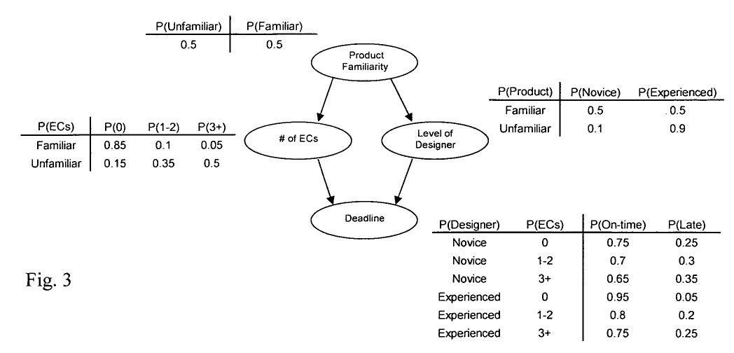

FIG. 4 illustrates a method according to one embodiment for eliciting information such as subjective probabilities for a Bayesian network.

FIG. 5 illustrates one example of a graphical interface according to one embodiment.

FIG. 6 illustrates one example of a graphical user interface being run in a training mode.

FIG. 7 illustrates a response scale according to one exemplary embodiment.

FIG. 8 illustrates one embodiment of a graphical user interface including a scaled probability bar.

FIG. 9 illustrates a table depicting changing conditional contexts for experts.

FIG. 10 illustrates a response scale including shaded overlays according to one embodiment.

### DETAILED DESCRIPTION

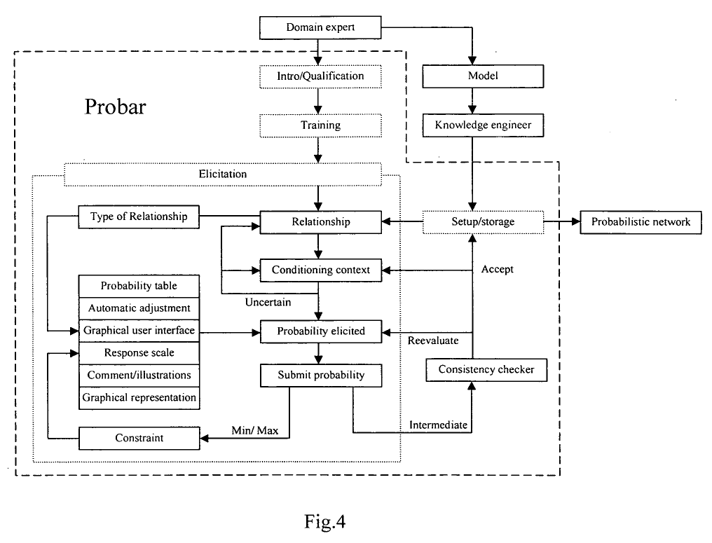

FIG. 4 depicts a system, according to one embodiment, for eliciting subjective probabilities for a Bayesian network designed to predict one or more outcomes based on a variety of causal relationships. More specifically, FIG. 4 depicts a computerized system configured to dynamically interact, by means of a graphical user interface, with experts in such a manner so as to elicit unbiased and consistent probabilities that can subsequently be utilized to aid in the modeling and problem solving capabilities of a probabilistic network.

The system of FIG. 4 comprises four main components or sub-systems, including: an introduction and qualification module, a training module, an elicitation module and a setup/storage module. FIG. 4 represents the system as the large shaded area that is outlined with a dashed line, while its four main sub-systems are also shaded, but outlined with a dotted line.

The introduction and qualification module explain the purpose of the study as well as collect information about an expert's background and familiarity with the domain. The training module acquaints the user with the elicitation process and explains the potential for bias and inconsistency.

The elicitation module queries and collects the expert's subjective probability, while evaluating bias and inconsistency. Within the elicitation module are several more components, including a procedure for altering the interface and routines based on various types of probabilistic relationships, conditioning contexts, a response scale, a graphical representation of probabilities, a probability table, automatic adjustments of probabilities, illustrations of relationships, constraints, routines for checking consistency and bias and a way for including notes, comments or technical illustrations. In FIG. 4, these are outlined by the dotted line extending from the elicitation module.

Finally, the setup and storage module provide a means for developing conditioning contexts and associated indices, incorporating reduction techniques and storing and compiling data.

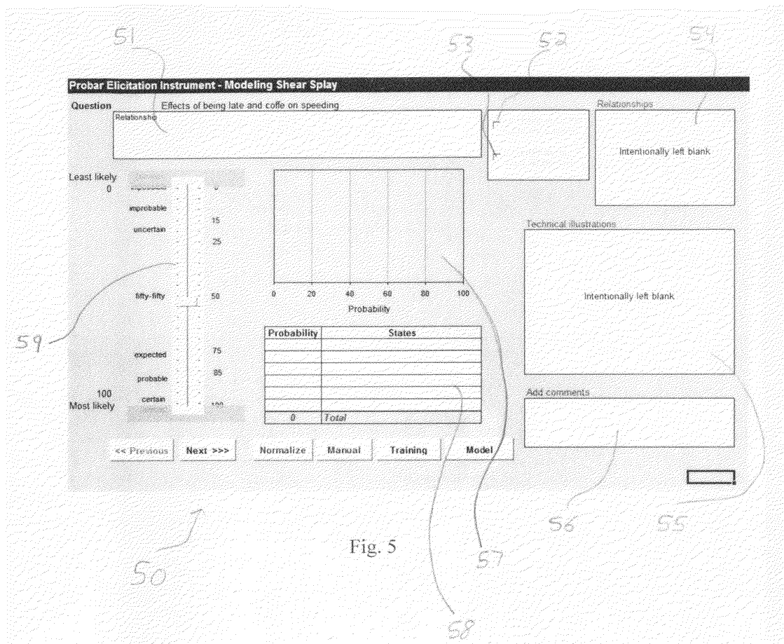

FIG. 5 is an example illustration of how the graphical interface generated by the system might appear. As illustrated in FIG. 5, graphical interface 50 can include a question area 51, various check-boxes 52 and 53 to indicate unfamiliarity with the topic (as discussed in greater detail below), a relationship area 54 to display the nodes and coordinate relationship, an area 55 to display technical illustrations, an area 56 for an expert or user to add comments, probability results in the form of a graph 57 (e.g., a bar graph or pie chart) and table 58, respectively, and a response scale 59 allowing a user or expert to enter their response to a question.

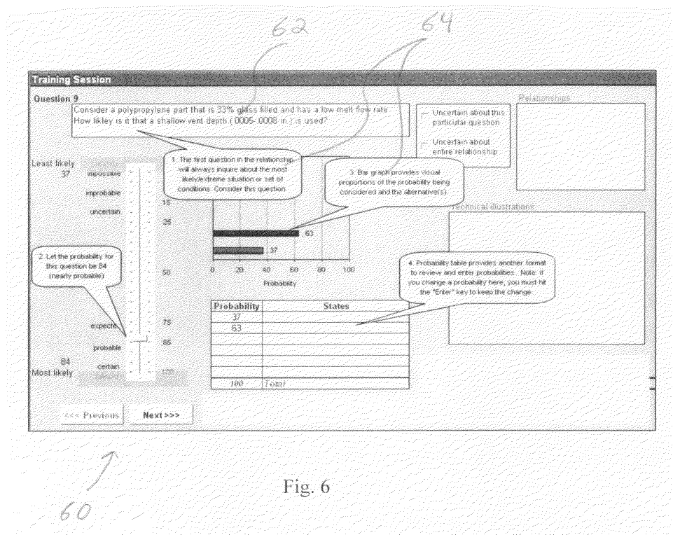

A more detailed explanation about the design of the system's four main modules, capabilities and novel features will now be presented with reference to FIGS. 6-10.

### Introduction and Qualification

Upon initiating the computerized system, the user is presented with an introduction about the project to which the system is being applied, as well as the components of the system. The system then conducts a quick survey following the introduction to determine the participant's professional background, experience and confidence level in answering various groups of questions. If an expert does not feel comfortable in assessing a particular group of questions, these questions can be omitted from the elicitation.

### Elicitation and Response

A graphical interface, such as graphical interface 50 of FIG. 5, can include user selectable options to indicate a person's discomfort or lack of confidence in assessing a particular group of questions. For example, according to one embodiment, the graphical interface as depicted in FIG. 5 includes two checkboxes. The first checkbox 52, labeled “Uncertain about this particular question” will result in a question being skipped if checkbox 52 is selected by the participant. Similarly, if the participant elects checkbox 53, thereby indicating that they are “Uncertain about the entire relationship”, all questions pertaining to the given relationship are skipped. However, before any questions are presented, the expert is prompted to explain his or her uncertainty through the addition of comments in a comments box 54. For both checkboxes 52 and 53, the letter “U”, for example, is recorded in place of the probability, signifying the expert was “uncertain” for this question or line of questions. During the training, experts are instructed to check these boxes if at any point they are unfamiliar or confused by any particular detail in the question.

### Training

Before answering any questions, a participant first undergoes a training session. The training session serves two purposes. First, it is implemented to explain the importance of consistency and the sources of biases.

Biases in probability elicitation occur in two general forms: motivational and cognitive. Motivational bias results when an individual feels his or her response will in some way impact him or herself. Whether their response is a reflection of their knowledge or means of getting a point across, the individual is vested in the outcome. Motivational bias is considered a conscious act. Therefore, it can be altered by properly explaining the intent of the elicitation process, careful selection of experts and sometimes with incentives.

Cognitive bias on the other hand, is unconsciously controlled and can be more problematic. It typically stems from relying on personal heuristics, which compromise the ability to accurately process, aggregate or integrate available data and information. Two similar forms of cognitive bias typically addressed in the training session are the availability error and the recency effect.

The availability error occurs when a person tends to remember certain events more readily than others, thus distorting their perception of the true frequency. The recency effect results when a disproportionate amount of recent events biases a person's assessment of reality. For example, an expert witnessing a series of manufacturing defects generated by the same cause may have difficulty remembering the years where the cause was never an issue, thus skewing their judgment. Other forms of cognitive bias are handled by measures in the elicitation instrument and are discussed in greater detail in the following sections.

The second purpose of the training is to provide practice in responding to the probability questions. It facilitates navigation through a trial elicitation exercise and explains the terms presented throughout the interface as well as the controls used to manipulate the graphical interface.

FIG. 6 is an illustrative example of a graphical user interface 60 that is designed for the elicitation of probabilities but currently being run in a training mode. According to this example embodiment, a user is presented with a demonstration on how to work the interface 60. Specifically, a system presents a test question 62, and then proceeds to guide the user in how to address the question through the use of various prompts such as pop-up explanations in the form of “balloons” 64. The training session also interactively educates a user about the measures installed to mitigate cognitive biases and the methods used to resolve them.

The various elements incorporated into the system and utilized throughout the assessment of probabilities to counteract biases will now be disclosed.

### Response Scale

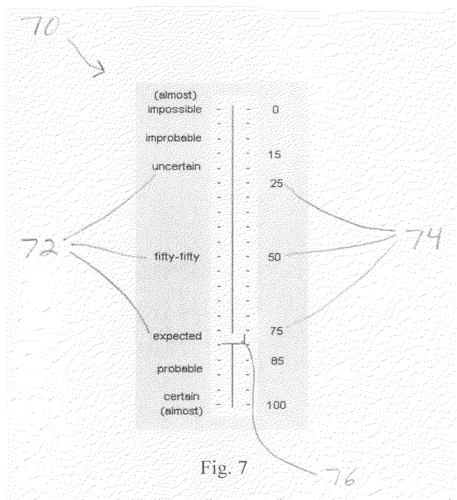

The response scale, one example of which is illustrated in FIG. 7, is designed to rapidly elicit a large number of subjective probability judgments. Specifically, the response scale 70 is presented as a two-sided scale containing both verbal anchors 72 and numerical anchors 74. Situated on one side of the scale or line are a series of unequally spaced verbal anchors 72, such as, for example, “(almost) certain”, “probable”, “expected”, “fifty-fifty”, “uncertain”, “improbable” and “(almost) impossible”. On the other side of the scale is a series of equivalent numerical anchors 74, such as, for example, 100, 85, 75, 50, 25, 15 and 0.

The two sets of anchors are slightly offset from one another to avoid a bias toward selecting the anchors because of their convenience. Another measure taken to reduce this bias included randomizing the starting position of the slider 76 from question to question. If the response scale 70 always resets the slider to fifty, for example, or remains at the value of the previous question, a tendency to not move the slider away from that value becomes more likely. This is a form of a bias called the anchoring and adjustment heuristic.

According to one embodiment, the scale 70 can also be computerized in the form of a slider 76 that shows the precise numeric value. Tick marks spaced in predefined intervals can be located on both sides of the scale, while precision of the slider 76 can be set, for example, to one. To set the probability, users simply click on the slider 76 and position it appropriately.

It should be noted that advantages exist for each type of anchor. For instance, when compared to numerical expressions, verbal expressions tend to be more intuitive and reflective of human probability judgments. However, the interpretation of verbally expressed probabilities is sometimes found to be more dependent on the context in which they are framed, thereby potentially resulting in greater within and between subject variability.

According to a further embodiment, the functionality of the system, and thus the accuracy and reliability of the elicited probabilities, can be improved by configuring the system to magnify the range and anchors of the response scale 70 for certain questions. Having the ability to focus in on a particular portion of the response scale 70 allows a user to provide more precise estimates, and thus avoid biases in overestimation and underestimation. In other words, magnifying a select range and anchors of the response scale 70 provides the experts interacting with the system with the opportunity to select a probability more in tune with their level of knowledge about a certain outcome.

In a further embodiment, this feature is employed on a case by case basis according to information obtained prior to elicitation that indicates a very low/high or very accurate probability is likely to exist. For example, the system may present one or more questions that are expected to elicit a response that falls within a limited range of the response scale, e.g., between 0 and 10%. In these instances, refining the range of the scale 70 can help avoid the base rate neglect bias, where people ignore relevant information, which is also called the base rate or prior probability. To assure that all participating experts are aware of any change in the response scale 70, the system would notify the user by means of a prompt which would have to be closed before the user can continue.

### Conditioning Context

The format for communicating probabilities to a participating expert is expressed in terms of likelihood. To illustrate, consider the following injection molding manufacturing-based example, wherein the probability question is presented as “Consider a polypropylene part that is black, has a high gloss level and has no texture. How likely is it that splay is visible?” Such a question format deviates slightly from the better supported frequency format, where experts are asked to recall registered events and transcribe the occurrence of a specific event into a frequency, such as 25 times out of 100 instances. Expressing probabilities in terms of likelihood is favored in the present embodiment as previous studies indicated that attempts to use the frequency format resulted in experts experiencing difficulty in visualizing the numbers or proportion of cases or events with a certain combination of characteristics when the condition was quite rare. Furthermore, when a large number of probabilities is being elicited, the use of likelihoods is preferred as it tends to make the activity less demanding on the participating experts.

### Graphical Representation of Entered Probabilities

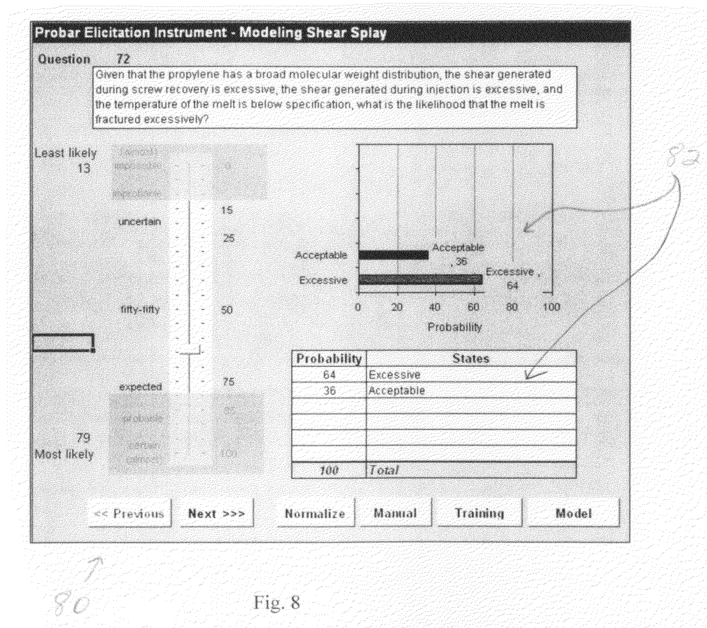

In one embodiment, the graphical interface further includes one or more graphics that indicate the probabilities entered by the user by means of the slider scale. This graphical representation of the user's entered value supports the likelihood format of the questions and facilitate experts in making more accurate assessments. As illustrated in the example graphical interface 80 of FIG. 8, a scaled probability bar (graph) 82 depicts the probability for each state within each conditional statement. Selecting a scaled probability bar is indicated based on studies where elicited probabilities learned from users playing a virtual cat-mouse game were compared with true probability distributions. The results showed that a scaled probability bar and probability wheel (pie chart) perform statistically better than direct numerical elicitation (e.g., typing numerical judgments directly into a conditional probability table). Furthermore, the elicitation time for a scaled probability bar was statistically faster than the elicitation times associated with other input confirmation means.

The availability of the graph is handled according to the number of states a variable possesses. For example, for binary-state variables, the bar graph, located to the right of the response scale, is always visible and updated immediately based upon the response scale. The first or bottom bar representing the elicited probability, while the second or top bar illustrates the alternative.

For multiple-state variables (more than 2), the bar graph is not made available until the probability for the last state is entered. This is intended to reduce the bias generated from the anchoring and adjustment heuristic, where humans overly rely on an initial estimate of a probability called an anchor, and then adjust it to account for new information. A related heuristic that can also potentially cause bias is the representativeness heuristic. Here, individuals judge the probability of an event on how closely it resembles other events. By eliciting probabilities individually for a single conditional context, an expert is refrained from resorting to these heuristics and, therefore, biases. Unfortunately, the above approach empowers experts to fall victim to an unbounded probability problem, where subjects overestimate each probability in a set of exhaustive and mutually exclusive scenarios, so that the estimated sum of all probabilities is greater than one.

### Procedure for Eliciting Probabilities

According to one embodiment, probabilities are elicited one at a time so as to further avoid a bias known as the spacing effect. Studies have demonstrated that if asked to indicate assessments for all conditional probabilities pertaining to a single variable given a single conditioning context on the same line, respondents will have a tendency to organize perceptual information so as to optimize visual attractiveness. In other words, individuals who have all the conditions presented at one time, such as in a matrix format, will submit their probabilities so that they appear to be correct relative to other probabilities.

Accordingly, the present embodiment groups probabilities by the same conditional distribution or situation. This reduces the number of times a mental switch of conditioning context is required. At any point in the elicitation process, the expert can review the coherence of his or her probability judgments by clicking the previous button. Upon switching to a different conditioning context, the system explains to the expert the upcoming relationships (including independent parent variables) in the question box.

In an effort to reduce the number of questions solicited during a study, the alternative probability for binary questions is not elicited. For instance, for two questions a) “ . . . How likely is it that condition A is visible?” and b) “ . . . How likely is it that condition A is not visible?”, only one or the other will be elicited by the system. It is assumed that between the response scale 70 and scaled probability bar 82, it is presumed that a user will understand the alternative condition of a binary question.

As for multiple-state variables, probabilities for conditions for every state of the child variable are elicited. Even though it is possible to deduce a final state by subtracting a sum of all elicited probabilities from one, the system will attempt to elicit probabilities for all states.

The reason for this programmed behavior is that in the event of an unbounded probability problem, the remaining state is typically found to be unusually low (or even negative) to make a sum of one.

According to another embodiment, two sets of conditional contexts can be constructed based on the aforementioned procedure. Then experts can be randomly assigned to one of the two contexts. This subsequently allows for an analysis of expert consistency and detection of biases.

### Randomized Conditional Contexts

To further reduce the chance of biases affecting elicited probability data, the system can be configured to randomize conditional contexts. Specifically, according to an additional embodiment, the state of a child variable in question can be randomized between variable relationships, but maintained within a given conditional context. Consequently, a chance that one expert responds to a group of conditional contexts that maintain the state “yes” while another expert responds to the contexts that maintain the alternative state “no” is random.

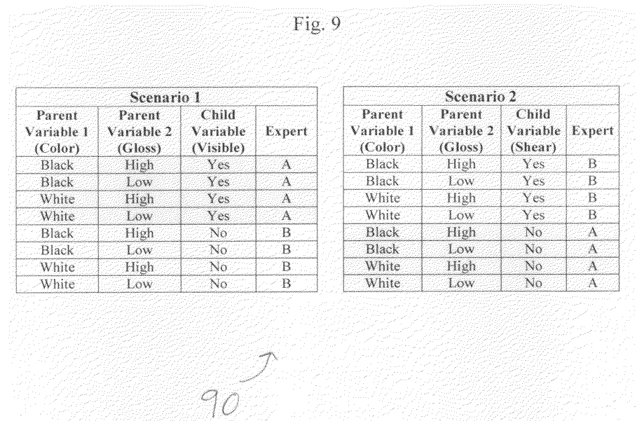

To illustrate the above condition, consider the example table 90 illustrated in FIG. 9, which shows a relationship where expert A replies to the conditions for the “yes” state, while expert B replies to the conditions for the “no” state. The other component to randomize in conditional contexts refers to the overall order of the variable relationships as they are presented to the expert. This allows an analysis of whether or not the order in which the questions are presented affects the consistency of the elicited probabilities. It may also allow the detection of biases that creep in over the duration of the elicitation.

### Minimum and Maximum Constraints

In one embodiment, conditional contexts are arranged so that the first two probabilities elicited by the system to the participant represent the most likely and least likely situations. As an expert enters these two probabilities, the upper and lower portions of the response scale become shaded. This is done to indicate to the expert that the subsequent probabilities they provide to the system should fall on the response scale so as to be outside of, or in-between, the shaded areas. However, one consequence of this configuration is that prior knowledge about the effects of the parent or conditioning variables must be known.

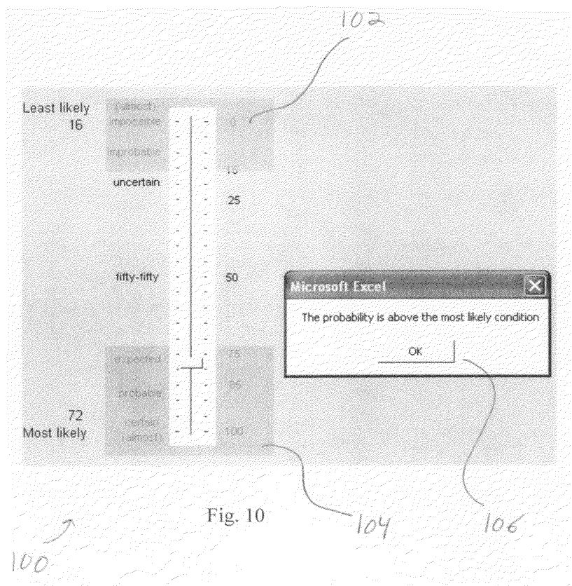

To demonstrate the above embodiment, see FIG. 10, which depicts a response scale 100. According to the example of FIG. 10, in response to a first question, an expert indicates that the maximum probability of a specified situation is 72%. In response, the system overlays a shaded section 104 upon the response scale 100 so as to indicate that 72% is the maximum probability and that all future elected probabilities should fall below this value. Then, in response to a second question, the expert indicates that the minimum probability of a situation is 16%. Similar to before, the system then proceeds to overlay a second shaded section 102 upon the response scale 100 so as to indicate that 16% is the minimum probability value.

If a participating expert enters a probability value that falls within one of the shaded regions 102 and 104, the system prompts 106 the expert and notifies him or her of the position. If the expert still wishes to submit the probability, he or she is asked to provide a reason in the comment box.

The imposition of minimum and maximum constraints reduce the chance for over estimations that result from neglecting previously submitted probabilities for the most and least likely conditions, which is a form of base rate neglect as well as conjunction fallacy. Base rate neglect occurs when an individual ignores prior information, while a conjunction fallacy happens when an individual assumes a more specific scenario to be more probable than a general scenario.

### Probability Adjustments

In accordance with another embodiment of the invention, the system is configured with two features that allow for experts to correct their overestimations that can occur in the event of an unbounded probability problem. Specifically, the system is configured to notify the expert via a message prompt upon detection of an overestimation. In response, the expert can either normalize the numbers or manually adjust them so that the numbers add up to 100. To execute the automatic normalize function, the expert clicks the normalize button and the modification is made automatically. Normalizing takes the probability of each state and divides it by the sum of all probabilities, thereby resulting in “relative” probabilities. The probability changes are subsequently shown in the scaled probability graph and in a table below the graph. The table lists the name of each state and the associated probabilities. At any point in the elicitation process, an expert can directly enter probabilities into the table. However, this method of direct elicitation is not suggested unless the cumulative probabilities exceed 100. Upon adjusting any probability, the total is updated immediately at the bottom of the table.

### Technical Illustrations

In another embodiment of the invention, communication is enhanced and the consistency of the elicited probabilities is improved through the use of technical illustrations and definitions. For instance, it is not uncommon for two different engineers to use two different descriptions for the same item, concept, etc. To address this possible source of discrepancies, the present embodiment specifies the use of a technical drawing that would aid in unifying an experts interpretation of the conditional contexts. In addition, the illustrations help to reduce the mental workload of the experts. By showing a comparison of the states, an expert does not have to draw his or her own mental image. This is especially important when you have experts that are either assessing situations that they have not dealt with before, or alternatively, are assessing situations that they have not dealt with in quite some time. The inclusion of technical illustrations in the graphical user interface also allows less intuitive expressions needed for modeling purposes to be depicted in terms that the experts could easily identify.

### Tracking Duration of Response

In a further embodiment, the system is configured to track the time at which each response is entered. As a result, the system can calculate and analyze the duration of time required to answer each question and each group of conditional contexts. Based on these times, a learning curve can be generated by the system. Correlations can then be drawn between the length of time and the variability for a particular question or group of questions. In addition, the overall amount of time it takes to complete the elicitation exercise can be documented.

### Record Keeping

One embodiment of the system also incorporates record keeping capabilities. When a participant of the elicitation exercise encounters an unbounded probability problem, it is useful to record the question for which this situation occurred. A count of the unbounded probability problems for each question can highlight conditional contexts that may be confusing. It is also likely that a count of unbounded probability problems relates to inconsistencies in the responses, or to questions with high variability. Questions with frequent unbounded probability problems may require rewording of the conditional context or a technical illustration to make the question more robust and comprehensible.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method of dynamically interacting with human experts to elicit information, such as subjective probabilities for a Bayesian belief network, in a manner that minimizes common biases and maximizes consistency in answers, comprising the steps of:
generating a graphical user interface for interaction with the expert;
surveying an expert's professional experience and familiarity with a topic;
training the expert by acquainting them with the graphical user interface and elicitation process;
educating the expert on potential biases and inconsistencies that can occur during an elicitation process; and
eliciting queries and collecting an expert's subjective probability via the graphical user interface.

2. The method according to claim 1, further comprising the steps of:
automatically skipping a current question if the expert indicates via the graphical user interface a feeling of uncertainty concerning the current question; and
automatically skipping all questions pertaining to a predefined relationship if the expert indicates via the graphical user interface a feeling of uncertainty concerning the predefined relationship.

3. The method according to claim 2, further comprising the step of automatically prompting the expert to submit a comment explaining the expressed uncertainty before presenting any additional queries.

4. The method according to claim 1, further comprising the step of requiring an expert to submit a probability by means of a graphical two-sided response scale having an input slider.

5. The method according to claim 4, wherein the response scale is configured with verbal anchors listed along one side of the scale and equivalent numerical anchors listed along another side of the scale.

6. The method according to claim 5, wherein the verbal anchors and numerical anchors are offset from one another so as to minimize any bias toward selecting anchors out of convenience.

7. The method according to claim 4, further comprising the step of randomizing a starting position of the input slider for every query so as to minimize any anchoring and adjustment heuristic bias.

8. The method according to claim 4, further comprising the step of automatically magnifying a selected range of the response scale so as to allow experts to provide more precise estimates and minimize overestimation and underestimation biases.

9. The method according to claim 1, further comprising the step of expressing a query to the expert in the format of a likelihood instead of a frequency.

10. The method according to claim 1, further comprising the step of depicting a scaled graph in the graphical user interface that indicates the probability values entered by the expert.

11. The method according to claim 10, wherein for binary state variables, the graph is always visible and is updated immediately in response to a probability value entered by an expert, while for multiple-state variables, the graph is not visible until a probability value for a last state is entered by the expert.

12. The method according to claim 1, wherein conditional probabilities are elicited one at a time instead of being presented as a collection so as to minimize any spacing effect bias.

13. The method according to claim 1, further comprising the step of ordering conditional contexts so that a first two probabilities elicited represent, respectively, a “most likely” scenario and a corresponding “least likely” scenario.

14. The method according to claim 13, further comprising the steps of:
requiring an expert to submit a probability by means of a graphical response scale having an input slider; and
imposing minimum and maximum constraints on elicited probabilities by graphically shading an upper and lower portion of the response scale on the basis of the first two elicited probabilities representing the “most likely” and “least likely” scenarios.

15. The method according to claim 1, further comprising the steps of:
automatically detecting an unbounded probability event wherein a collection of related probability values submitted by the expert either overestimates or underestimates the event; and
prompting the expert to manually adjust previously submitted probability values so that a sum of these values no longer overestimates or underestimates the event.

16. The method according to claim 1, further comprising the steps of:
automatically detecting an unbounded probability event wherein a collection of related probability values submitted by the expert either overestimates or underestimates the event; and
automatically normalizing the submitted probability values by dividing each related probability value by a sum of all related probability values.

17. The method according to claim 1, further comprising the step of displaying a technical illustration in the graphical user interface that aids in unifying an interpretation of a conditional context held by experts.

18. The method according to claim 1, further comprising the step of generating a learning curve based upon a duration of time taken by an expert to answer each question.

19. A method of gathering knowledge from human experts by eliciting relatively unbiased and consistent probabilities, comprising the steps of:
generating a graphical user interface with which the expert interacts;
surveying an expert's professional experience and familiarity with a topic by means of the graphical user interface;
acquainting the expert with the graphical user interface and elicitation process;
educating the expert on potential biases and inconsistencies that can occur during an elicitation process;
eliciting queries and collecting an expert's subjective probability via an input slider contained within a response scale depicted within the graphical user interface;
depicting all related probability values entered by the expert in a scaled graph contained within the graphical user interface; and
imposing minimum and maximum constraints on elicited probabilities by graphically shading an upper and lower portion of the response scale on the basis of elicited probabilities representing the “most likely” and “least likely” scenarios.
